(19) United States
(12) Patent Application Publication
(10) Pub. No.: US 2025/0317021 A1
(43) Pub. Date: Oct. 9, 2025

(54) DUAL-LAYER WAVE WINDING MAT AND POWER-DEPENDENT COMPONENT HAVING A DUAL-LAYER WAVE WINDING MAT

(71) Applicant: ZF FRIEDRICHSHAFEN AG, Friedrichshafen (DE)

(72) Inventors: Kai MEHLSTÄUBL, Neidlingen (DE); Robin MICHELBERGER, Schweinfurt (DE); Matthias EBERT, Himmelstadt (DE)

(21) Appl. No.: 18/866,245

(22) PCT Filed: May 12, 2023
(86) PCT No.: PCT/EP2023/062729

§ 371 Date: Nov. 15, 2024

(30) Foreign Application Priority Data
May 17, 2022 (DE) 10 2022 204 815.6

(51) Int. Cl. H02K 3/28

(52) U.S. Cl. CPC H02K 3/28

(57) ABSTRACT

A dual-layer wave winding mat for power-dependent component of an electric machine, formed of a first mat and an identical second mat, each having at least one conductor strand which includes at least one conductor formed in parallel webs and winding heads which connect the latter to one another. The webs of the first mat and the webs of the second mat are arranged to alternate in a first mat plane and a second mat plane. The first mat and the second mat are arranged to be offset relative to one another such that a single-layer start region is formed only by the first mat and a single-layer end region is formed only by the second mat.

### CROSS REFERENCE TO RELATED APPLICATIONS

This is a U.S. national stage of Application No. PCT/EP2023/062729 filed May 12, 2023. Priority is claimed on German Application No. DE 10 2022 204 815.6 filed May 17, 2022 the content of which is incorporated herein by reference.

### BACKGROUND OF THE INVENTION

### 1. Field of the Invention

The disclosure is directed to a dual-layer wave winding mat for a rotor or stator, hereinafter power-dependent component of an electric motor, a power-dependent component with such a winding mat, an electric motor with such a power-dependent component, and a vehicle with such an electric motor.

### 2. Description of the Related Art

Electric motors for vehicles comprise a stator and a rotor as power-generating components. Both of these component parts are assembled from laminations that are insulated from one another and stacked one upon the other and which form a cylindrical lamination stack and are formed in each instance as an annulus having circumferential slots. Individual conductors, generally flat copper wires or conductor strands comprising individual conductors connected in parallel with one another, are wound around the slots and respectively form the winding of a coil.

One possibility for winding these coils is wave winding technology by which wave winding mats are usually prepared which are inserted into the slots and subsequently contacted. In this regard, it is important that all of the elements of the power-generating component be insulated from one another, for example, by films or paper. Lastly, the slots are sealed with slot liners and potted with a casting medium for better durability and insulation.

Wave winding is advantageous because this type of winding can be carried out in a particularly cost-effective manner and is automatable. Further, the wave winding brings about a better engine performance compared with the otherwise conventional concentrated winding.

In wave winding, a conductor is repeatedly guided through a slot, spans a fixed number of slots and is guided through a further slot. The area of the conductor spanning a plurality of slots is referred to as a winding head. The area guided inside of a slot makes up a conductor portion. A plurality of conductors is wound around the power-generating component of the electric machine or electric motor in its entirety in this way in a plurality of winding layers. The winding layer of the conductor is the radial position of the conductor within the respective slot. To maximize efficiency, smooth running and robustness, it is necessary to selectively adapt the path of the individual conductors to one another. In this regard, it is also necessary, inter alia, to change the arrangement of individual conductors in a winding layer in a slot jump.

In order to meet determined requirements for torque and power with an electric machine, it is necessary to form the machine with a number of turns adapted to the installation length. In a wave winding mat, the number of turns is determined by the number of conductor portions (webs) guided within a slot of the machine and a number of conductors connected in parallel with one another in the wave winding mat as expressed by the formula w=p*q*z/a, where w is the effective number of turns in the machine, n is the number of conductor portions per slot, a is the number of conductors connected in parallel in a wave winding mat, p is the number of pole pairs, and q is the number of slots per magnetic pole and phase (hole number). Thus n=2*p*q*r, where n is the total number of slots and r is the number of phases of the machine.

In most of the methods known from the prior art for producing a wave winding mat, the individual conductors or conductor strands are wound offset to one another in the same winding direction and interwoven through layer changes. The conductor portions are fitted into slots of the stator or rotor all in one winding layer and are therefore considered single-layer wave winding mats.

Meanwhile, methods have also been developed in which two single-layer wave winding mats are simultaneously integrated in one another to produce dual-layer wave winding mats in that the conductors or conductor strands are wound in opposite directions and interwoven via layer changes. In the end, wave winding mats which, at only half of the length, have the same effective number of turns as a single-layer wave winding mat with an identical winding scheme can be produced in this way. This represents an enormous saving of time and production costs are therefore reduced. A drawback consists in that the quantity of conductor portions per slot (number of winding layers) is no longer freely selectable but, instead, must always be an even number and the possible combinations of number of layers, number of conductors connected in parallel in the wave winding and number of holes are very limited. As a result, the power requirements and torque requirements imposed on the electric machine must usually be significantly outperformed, which leads to a higher weight requirement and installation space requirement.

### SUMMARY OF THE INVENTION

It is an object of one aspect of the invention to modify a dual-layer wave winding mat in such a way that an odd number of winding layers can be realized for a winding. It is also an object of one aspect of the invention to find a power-dependent component with such a wave winding mat, an electric motor with such a power-dependent component and a vehicle with such an electric motor.

For a dual-layer wave winding mat formed of a first mat and an identical second mat, each having at least one conductor strand which comprises at least one conductor which is formed in a recurring winding pattern in parallel webs and winding heads which connect the latter to one another, and in which the webs of the first mat and the webs of the second mat are arranged to alternate in a first mat plane and a second mat plane, the above-stated object is met in that the first mat and the second mat are arranged to be offset relative to one another in a longitudinal direction perpendicular to the webs such that a single-layer start region is formed only by the first mat of the wave winding mat and a single-layer end region is formed only by the second mat of the wave winding mat, and the webs of the first mat and the webs of the second mat are arranged to overlap one another in pairs between the start region and the end region.

The start region and the end region advantageously have an identical length.

For a power-dependent component for an electric motor, which power-dependent component comprises a lamination stack with a plurality of radially extending slots and a dual-layer wave winding mat according to one aspect of the invention inserted into the slots to form a plurality of concentric winding layers, the above-stated object is met in that the start region is arranged in the first winding layer of the winding layers and the end region is arranged in the last winding layer of the winding layers, and the start region and end region together have a length which corresponds to the length of a portion of the wave winding mat that is arranged in one of the winding layers.

The start region in the first winding layer of the winding layers advantageously covers a first half, and the end region in the last winding layer of the winding layers advantageously covers a second half.

It is advantageous that the inputs of the at least one conductor of the first mat and of the at least one conductor of the second mat are arranged opposite one another in the last winding layer of the winding layers, and the outputs of the at least one conductor of the first mat and of the at least one conductor of the second mat are arranged opposite one another in the first winding layer of the winding layers.

The above-stated object is met for an electric motor in that it comprises a power-dependent component according to the invention.

The above-stated object is met for a vehicle in that it comprises an electric motor with a power-dependent component according to the invention.

It will be understood that the features mentioned above and those yet to be explained below may be used not only in the stated combinations but also in other combinations or alone without departing from the scope of the present invention.

### BRIEF DESCRIPTION OF THE DRAWINGS

The invention will be explained in more detail in the following by examples with reference to the accompanying drawings which also disclose key features of the invention. These embodiment examples are provided merely to be illustrative and should not be considered as restrictive. For example, a description of an embodiment example having a plurality of elements or components should not be interpreted to mean that all of these elements or components are necessary for its implementation. On the contrary, other embodiment examples may also contain alternative elements and components, fewer elements or components, or additional elements or components. Elements or components of different embodiment examples can be combined with one another unless otherwise stated. Modifications and alterations which are described for one of the embodiment examples may also be applicable to other embodiment examples. Like or comparable elements in the various figures are designated by the same reference numerals and not mentioned repeatedly so as to avoid repetition. The drawings show:

FIG. 1 is a wave winding mat with two conductors;

FIG. 2 is a winding scheme for a wave winding mat;

FIG. 3 is winding scheme for the wave winding mat according to FIG. 2 inserted into the slots of the power-dependent component; and

FIG. 4 is a schematic top view of the inserted wave winding mat.

### DETAILED DESCRIPTION OF THE PRESENTLY PREFERRED EMBODIMENTS

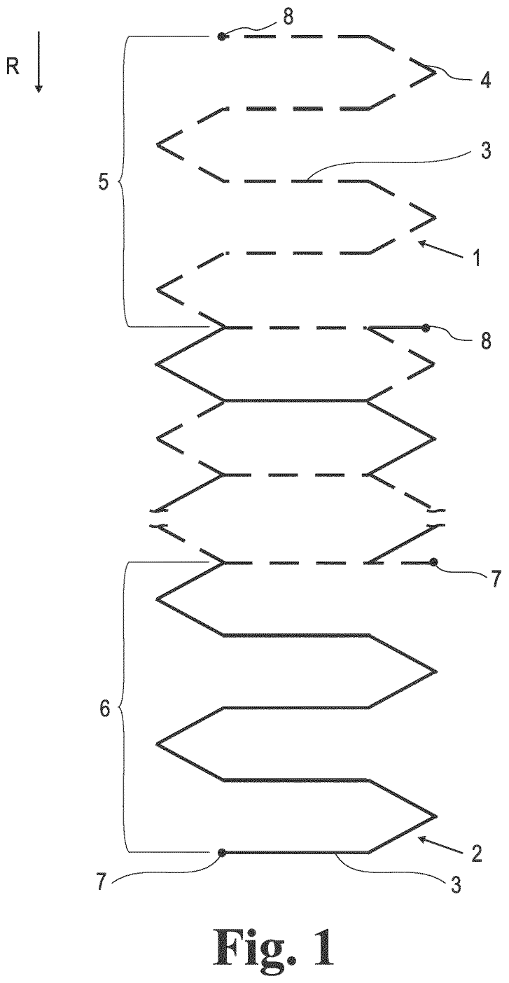

FIG. 1 shows a dual-layer wave winding mat according to the invention in a view restricted to only one conductor per mat. The dual-layer wave winding mat is formed from a first mat 1 and a second mat 2, which are arranged offset to one another in a longitudinal direction R. The conductor, only one of which is shown for the first mat 1, is formed by a plurality of webs 3 and winding heads 4 connecting the latter to one another and is shown here as a dashed line. The conductor, the only one shown for the second mat 2, is formed by an identical plurality of webs 3 and winding heads 4 connecting the latter to one another and is shown here as a solid line. All of the webs 3 run parallel to one another. Webs adjacent to one another in longitudinal direction R have a predetermined distance from one another which corresponds to the multiple of a slot spacing of a power-dependent component of an electric motor for which this winding wave mat was specifically designed.

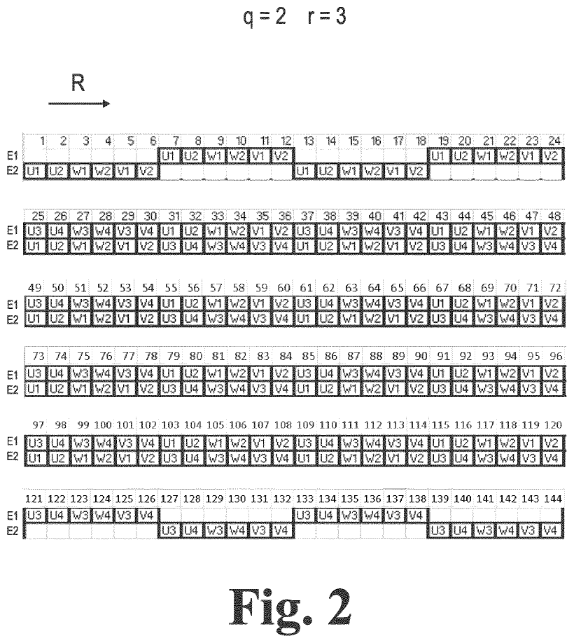

In the present instance, the webs 3 of the first mat 1 represent conductor portions of conductors U1, U2, W1, W2, V1 or V2 of the winding scheme shown in FIG. 2. The webs 3 of the second mat 1 represent conductor portions of conductors U3, U4, W3, W4, V3 or V4 of the winding scheme known in FIG. 2. When the depicted conductor of the first mat 1 is envisioned as the U1 conductor, the conductor is inserted in every sixth slot starting from the first slot. Consequently, the predetermined spacing of the adjacent webs 3 of the conductor corresponds to the x6 slot spacing.

The conductors have a layer jump in each instance in the winding heads 4 so that the webs 3 are arranged alternately in a first mat plane E1 and a second mat plane E2 as is clearly shown in FIG. 2, e.g., referring to the start region passing over web positions 1-24. The webs 3 in the first mat plane E1 and second mat plane E2 lie one above the other in the dual-layer region between the start region 5 and the end region 6 where the first mat 1 and the second mat are interwoven. The upper web 3, that is, the web lying in the second mat plane E2, was shown in FIG. 1.

An advantageous example for a wave winding mat is shown in FIG. 2 in a winding scheme. It has 3×48=144 webs parallel to one another in the start region and end region or web pairs in the dual-layer region therebetween. Each of the parallel webs 3 or web pairs is located at a consecutively numbered web position. The start region 5 and the end region 6 each comprise 48/2=24 webs 3 so that the start region 5 and the end region 6 are equally long and are each one fourth as long as the length of the dual-layer region. They could also have different lengths, provided the sum of the webs 3 in the start region 5 and the end region 6 equals 48. The wave winding mat shown here has the phase number r=3 designated by U, V and W. It has a hole number q=2, i.e., two web positions are occupied adjacent to one another per phase and magnetic pole.

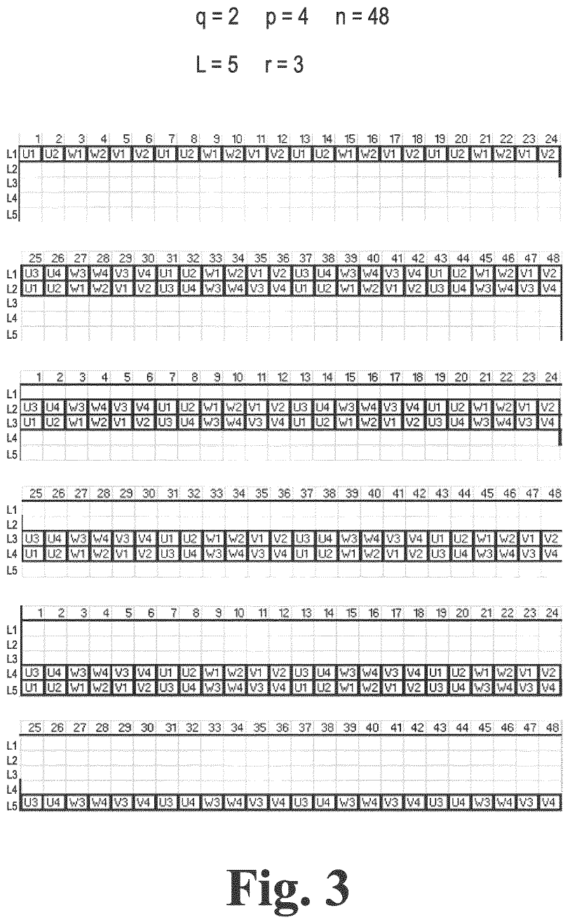

FIG. 3 shows a winding scheme for the wave winding mat according to FIG. 2 inserted in the slots of the power-dependent component of an electric motor.

The power-dependent component has 48 slots so that the wave winding mats are mounted in the slots with 144 webs or web pairs in three complete revolutions. By radially compressing the wave winding mat, the webs 3 of web positions 1 to 24 lie in the first winding layer L1 and the web pairs of web positions 25 to 48 lie in the first winding layer L2 and second winding layer L3, while the subsequent web positions continue to be stacked thereon until, finally, five webs are inserted in all 48 slots and a five-layer winding is formed.

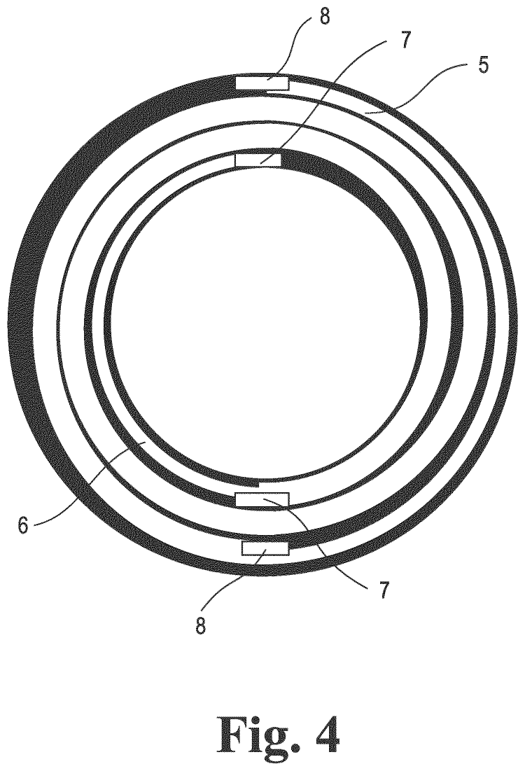

FIG. 4 shows the inserted wave winding mat schematically in a top view. The single-layer start region 5, the dual-layer region and the single-layer end region 6 are shown by the different radial thickness. The outputs 8 of the conductors of the first mat 1, which by itself forms the start region 5, and the outputs 8 of the second mat 2 at the transition to the dual-layer region of the wave winding mat are arranged opposite one another radially outwardly. The inputs 7 of the conductors of the second mat 2, which by itself forms the end region 6, and the inputs 7 of the first mat at the transition to the dual-layer region of the wave winding mat are arranged opposite one another radially inwardly.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A dual-layer wave winding mat for a power-dependent component of an electric machine, comprising:
a first mat and an identical second mat, each having at least one conductor strand which comprises at least one conductor which is formed in parallel webs and winding heads which connect respective parallel webs to one another,
wherein the webs of the first mat and the webs of the second mat are arranged to alternate in a first mat plane and a second mat plane,
wherein the first mat and the second mat are arranged to be offset relative to one another in a longitudinal direction perpendicular to the webs such that a single-layer start region is formed only by the first mat and a single-layer end region is formed only by the second mat, and
wherein the webs of the first mat and the webs of the second mat are arranged to overlap one another in pairs between the start region and the end region.

9. The dual-layer wave winding mat according to claim 8, wherein the start region and the end region have an identical length.

10. A power-dependent component for an electric motor, comprising:
a cylindrical lamination stack with a plurality of radially extending slots; and
a dual-layer wave winding mat, comprising:
a first mat and an identical second mat, each having at least one conductor strand which comprises at least one conductor which is formed in parallel webs and winding heads which connect the parallel webs to one another,
wherein the webs of the first mat and the webs of the second mat are arranged to alternate in a first mat plane and a second mat plane,
wherein the first mat and the second mat are arranged to be offset relative to one another in a longitudinal direction perpendicular to the webs such that a single-layer start region is formed only by the first mat and a single-layer end region is formed only by the second mat, and
wherein the webs of the first mat and the webs of the second mat are arranged to overlap one another in pairs between the start region and the end region
wherein the dual-layer wave winding mat is inserted into the slots to form a plurality of concentric winding layers,
wherein the start region is arranged in the first winding layer of the winding layers and the end region is arranged in a last winding layer of the winding layers, and the start region and end region together have a length which corresponds to a length of a portion of the wave winding mat that is arranged in one of the winding layers.

11. The power-dependent component for an electric motor according to claim 10, wherein the start region in the first winding layer of the winding layers covers a first half, and the end region in the last winding layer of the winding layers covers a second half.

12. The power-dependent component according to claim 10,
wherein inputs of the at least one conductor of the first mat and of the at least one conductor of the second mat are arranged opposite one another in the last winding layer of the winding layers, and
wherein outputs of the at least one conductor of the first mat and of the at least one conductor of the second mat are arranged opposite one another in the first winding layer of the winding layers.

13. An electric motor comprising:
a power-dependent component, comprising:
a cylindrical lamination stack with a plurality of radially extending slots; and
a dual-layer wave winding mat, comprising:
a first mat and an identical second mat, each having at least one conductor strand which comprises at least one conductor which is formed in parallel webs and winding heads which connect the parallel webs to one another,
wherein the webs of the first mat and the webs of the second mat are arranged to alternate in a first mat plane and a second mat plane,
wherein the first mat and the second mat are arranged to be offset relative to one another in a longitudinal direction perpendicular to the webs such that a single-layer start region is formed only by the first mat and a single-layer end region is formed only by the second mat, and
wherein the webs of the first mat and the webs of the second mat are arranged to overlap one another in pairs between the start region and the end region
wherein the dual-layer wave winding mat is inserted into the slots to form a plurality of concentric winding layers,
wherein the start region is arranged in the first winding layer of the winding layers and the end region is arranged in a last winding layer of the winding layers, and the start region and end region together have a length which corresponds to a length of a portion of the wave winding mat that is arranged in one of the winding layers.

14. A vehicle with an electric motor comprising:
a power-dependent component, comprising:
a cylindrical lamination stack with a plurality of radially extending slots; and
a dual-layer wave winding mat, comprising:
a first mat and an identical second mat, each having at least one conductor strand which comprises at least one conductor which is formed in parallel webs and winding heads which connect the parallel webs to one another,
wherein the webs of the first mat and the webs of the second mat are arranged to alternate in a first mat plane and a second mat plane,
wherein the first mat and the second mat are arranged to be offset relative to one another in a longitudinal direction perpendicular to the webs such that a single-layer start region is formed only by the first mat and a single-layer end region is formed only by the second mat, and
wherein the webs of the first mat and the webs of the second mat are arranged to overlap one another in pairs between the start region and the end region
wherein the dual-layer wave winding mat is inserted into the slots to form a plurality of concentric winding layers,
wherein the start region is arranged in the first winding layer of the winding layers and the end region is arranged in a last winding layer of the winding layers, and the start region and end region together have a length which corresponds to a length of a portion of the wave winding mat that is arranged in one of the winding layers.
